(19) United States
(12) Patent Application Publication
(10) Pub. No.: US 2026/0086280 A1
(43) Pub. Date: Mar. 26, 2026

(54) NON-VOLATILE OPTICAL MEMORY BANK WITH III-V/SI MICRO-RING LASER ARRAYS

(71) Applicant: HEWLETT PACKARD ENTERPRISE DEVELOPMENT LP, Spring, TX (US)

(72) Inventors: STANLEY CHEUNG, Milpitas, CA (US); YUAN YUAN, Milpitas, CA (US); BASSEM TOSSOUN, Santa Barbara, CA (US); YANIR LONDON, Spring, TX (US); YIWEI PENG, Spring, TX (US); GEZA KURCZVEIL, Santa Barbara, CA (US); YINGTAO HU, Santa Barbara, CA (US)

(21) Appl. No.: 18/891,356

(22) Filed: Sep. 20, 2024

(51) Int. Cl. G02B 6/12; G02B 6/293

(52) U.S. Cl. CPC G02B 6/12007; G02B 6/29338; G02B 6/29395

(57) ABSTRACT

Systems and methods are provided for non-volatile optical storage devices. The examples comprise a light emitting device that leverages an integrated charge-trap memory (CTM) device for non-volatile retention of wavelength tuning. In examples, a light emitting device is formed from a first semiconductor layer is formed on a second semiconductor layer having a dielectric layer therebetween. The light emitting device emits light into a waveguide comprising in the second semiconductor layer. A non-volatile memory device is integrated with the light emitting device in the waveguide. One or more power sources can be operated to apply a seed voltage to the first semiconductor layer that causes the light emitting device to emit light, and apply a voltage bias across the non-volatile memory device to tune the wavelength of the light. The tuning can be retrained after the voltage bias is removed.

### STATEMENT OF GOVERNMENT RIGHTS

This invention was made with Government support under Agreement Number H98230-18-3-0001. The Government has certain rights in the invention.

### BACKGROUND

Developments in large-scale data processing have increased demands for high levels of computing performance, for example, in large-scale data processing and artificial intelligence (AI) applications. Optical computing, which leverages optical technology to achieve increased transmission speed and energy efficiencies compared to traditional electrical methods, can accelerate computation performance. Optical computing uses light waves produced by optical sources, such as lasers or incoherent sources, for data processing, data storage, and/or data communication for computing applications

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example optical system in accordance with examples of the present disclosure.

FIGS. 2A and 2B depict a schematic diagram of another example optical system in accordance with an illustrative implementation of the present disclosure.

FIGS. 3A and 3B show example carrier-trap occupation probabilities of the optical system according to examples of the present disclosure.

FIGS. 4A-4C illustrate examples of non-volatile wavelength shifts provided by optical system according to examples of the present disclosure.

FIG. 5 is a schematic diagram of an optical memory bank in accordance with examples disclosed herein.

FIG. 6 is an example computing component that may be used to implement various features of non-volatile optical memory in accordance with the implementations disclosed herein

FIG. 7 is a computing component that may be used to implement examples of the disclosed technology.

The figures are not exhaustive and do not limit the present disclosure to the precise form disclosed.

### DETAILED DESCRIPTION

The present disclosure provides for optical devices comprising a light emitting device that leverage an integrated charge-trap memory (CTM) device adapted for non-volatile retention (e.g., non-volatile storage) of wavelength tuning. As used herein, “non-volatile” refers to an ability to retain (e.g., store) a state even in the absence of supplied power or voltage. In the case of examples disclosed herein, optical devices are provided that can retrain a wavelength tuning state without requiring power to be supplied to the device. In some examples, an array of optical memory devices can be arranged on a common bus waveguide, thereby providing a non-volatile optical memory bank. Through non-volatile retention of the wavelength tuning state, the optical devices disclosed herein can be implemented in large scale photonic systems, with reduced power consumption as the disclosed optical memory device can be operated with minimal or negligible power consumption.

As alluded to above, optical computing may be leveraged to accelerate computing performance. Optical computing has focused on replacing conventional electrical computer components with optical equivalents, resulting in an optical digital computer system. For example, high-speed optical interconnects have been implemented in computing architectures, as well as optical neuromorphic computing chips. The result is the integration of optical components into traditional computers that provides optical-electronic hybrid computing. However, optoelectronic devices consume energy converting electronic energy into photons and back, which delays computations. All-optical computers can eliminate the need for optical-electrical-optical (OEO) conversions, thereby reducing power consumption.

However, unlike random access memory (RAM) and flash memory implemented using electronic integrated circuits (EICs), optical memory has proven to be difficult to implement on photonic integrated circuits (PICs), which poses a challenge to storing information within PICs. When information is stored on an EIC implemented memory, retrieval of the stored information may necessitate OEO conversions due to communication between the PICs and EICs. The OEO conversions cause latency that can constrain the computation speed (e.g., in terms of operations per second) and can prevent the PIC from realizing its full capability. Thus, using optical-based data storage for data exchanges could significantly boost performance of optical computing systems by minimizing latency and reducing power energy consumption. For example, optical-based storage device can minimize and possible eliminate OEO conversion instances due to data exchanges with electrically-based storage devices, which can eliminate the corresponding latencies and static energy consumption.

Non-volatile memory devices for storing data can be classified as floating gate type non-volatile memory (FGM) devices and charge trap type non-volatile memory (CTM) devices, depending on the type of storage layer that utilized in the memory unit cell. FGM devices can be adapted to store charges in a floating gate, whereas the CTM devices can be adapted to accumulate charges in traps existing in an insulating layer. Conventionally, FGM devices may require high voltage for program and erase operations when the cell size is reduced. In contrast, CTM devices can be operated at lower power and lower voltage requirements. In CTM devices, charges of several energy levels can be trapped at due to distribution characteristics of trap energy.

Existing approaches have attempted to provide optically implemented FGM and CMT devices. However, the existing devices are subject to limitations in power consumption due to relatively higher voltages required to perform program and erase operations (also referred to herein as set and reset, respectively). The existing optical CTM devices suffer from similar limitations due to high voltages needed to realize the charge trapping characteristics. Furthermore, existing FGM and CTM devices may only be able to realize one bit storage due to the availability of a single state. Further still, the conventional devices rely on external optical sources for supplying light, further increasing the power consumption requirements.

The technology according to the present disclosure overcome the above technical shortcomings of existing optical memory devices by integrating non-volatile memory devices with light emitting devices to provide non-volatile wavelength tuning. Non-volatile wavelength tuning, according to the examples herein, can provide for minimal (e.g., near zero) static power consumption, while also permitting reduced voltages for program and erase operations as compared to the conventional approaches. By applying a set voltage bias (also referred to as a program voltage bias) and then removing the voltage bias, a wavelength of light emitted by the optical memory devices disclosed herein can be tuned (e.g., set or programmed) and maintained with minimal or even zero power consumption beyond that necessitated by the set voltage bias. Through the minimal power consumption, the implementations disclosed herein find suitability for a number of applications, for example but not limited to, photonic accelerators, neuromorphic computing, data communications, telecommunications, radio-frequency photonics, and any other system that requires energy efficiency. Furthermore, the examples disclosed herein can be realized as using heterogeneous Group III-V/Si structure, which can be integrated into existing heterogeneous Si platforms through known bonding techniques. For example, the presently disclosed examples can be integrated into PICs as optical sources that can be tunable with minimal power consumption.

As alluded to above, the presently disclosed technology provides for optical devices having a light-emitting device with an integrated non-volatile memory device on a silicon platform. In examples, the light-emitting device may be operated to generate and emit light (e.g., an optical signal) at a first wavelength, while the non-volatile memory device can be operated to tune the wavelength of the emitted light to a second wavelength. For example, the light emitting device can be operated to emit light that is injected into or otherwise coupled into an optical waveguide by traversing an insulating interface. In various examples, the second wavelength may be blue-shifted relative to the first wavelength (e.g., the second wavelength may be less than the first wavelength). The insulating interface may comprise defect sites that result in carrier traps (also referred to herein as “traps” or “trap regions”). The non-volatile memory device may be operated by applying a first voltage bias as a set voltage bias that causes an increased concentration of free charge carriers (e.g., holes and/or electrons) at the boundary of the insulating interface. The increased free charge carrier concentration leads to an accumulation of free charge carriers being trapped in the traps. The trapped carriers exhibit a non-volatile characteristic in that they remain trapped (e.g., a trapped state) permanently irrespective of whether or not the first voltage bias is applied. The accumulation of trapped carriers at the insulating interface can induce a change in a refractive index of the optical waveguide. For example, the trapped carriers can cause a non-volatile plasma dispersion effect that permanently (e.g., until the reset voltage bias is applied) alters the refractive index of the waveguide and causes a non-volatile change in the wavelength.

To reset the device, a second voltage bias (also referred to as a reset voltage bias) can be applied that reverts the wavelength of light back to the first wavelength. For example, by applying the second voltage bias to the non-volatility memory device, while free charge carriers are in a trapped state, can release the trapped carriers. The release of the carriers can cause the refractive index of the optical waveguide to return to its original state (e.g., original value) and the wavelength of light can return to the first wavelength.

In an example implementation, the disclosed optical devices may include a resonator structure that includes an optical waveguide and the light emitting device that generates and injects light into an optical waveguides. In some examples, the resonator structure may be a ring resonator (e.g., a micro-ring resonator) having a resonance frequency that is based on a radius of the ring and an index of refraction of the optical waveguide. The light emitting device may generate light based on a seed voltage bias applied thereto, which stimulates light emission. The emitted light can then be injected into the optical waveguide and propagates in the optical waveguide at a wavelength corresponding to the resonance frequency of the resonator structure. This resonance frequency may correspond to the first wavelength or any of the second wavelengths depending on the state of the non-volatile memory device.

In various examples, the resonator structure may comprise a heterogeneous metal oxide semiconductor capacitor (MOSCAP) integrated into the resonator structure with the light emitting device. Carrier accumulation may be induced within an insulating interface, such as a dielectric layer, of the MOSCAP by applying a first voltage bias. In some examples, the first voltage bias may be a reverse voltage bias. The accumulation of free charge carriers in the insulating interface results in an accumulation of trapped carriers that causes the non-volatile change in the refractive index of the optical waveguide. This change in the refractive index leads to a non-volatile change in the resonance frequency of the resonator structure and, ultimately, a non-volatile change in the wavelength of light propagating in the resonator structure. Applying a second voltage bias to the MOSCAP at a polarity opposite to that of the first voltage bias releases the trapped carriers and resets the resonance frequency.

The resonator structure can be optically coupled to a bus waveguide via an optical coupler that evanescently couples light propagating in the resonator structure into the bus waveguide. The coupled light propagates along the bus waveguide for downstream processing and applications.

According to some examples, the disclosed device can be tuned to one of a plurality of different wavelengths by adjusting the first voltage bias to different bias levels. Each bias level may result in a respective change in the refractive index of the optical waveguide, resulting tuning to a respective wavelength of light. For example, a first voltage bias at a first bias level may tune the light emitted by the light emitting device to the second wavelength. Tuning the first voltage bias to a second bias level may tune the light emitted by the light emitting device to a third wavelength. A third bias level may result in a fourth wavelength, and so on. In examples, a larger bias level (e.g., absolute value) may cause a larger shift relative to the first wavelength. That is, for example, the wavelength shift from the first wavelength to the second wavelength may be less than the wavelength shift from the first wavelength to the second wavelength. In examples, applying a first voltage bias causes a blue-shift relative to the first wavelength (e.g., smaller wavelengths) and larger bias levels causes an increasing large blue shifts. Thus, the optical devices disclosed herein can be programmed (e.g., set) to a number of different states, represented as different wavelengths, through selective tuning of the first voltage bias.

In an example, a plurality of optical devices according to the present disclosure can be optically coupled to the bus waveguide as an array of optical devices (also referred to as an optical memory bank). In this case, each optical device, which can be considered a unit cell of the memory bank, may comprise a respective light emitting device integrated with a non-volatile memory device. Accordingly, as described above, each unit cell may be tuned to a different wavelength through application of a respectively different first voltage bias (e.g., different bias levels), resulting in light emitted by each unit cell at a respective wavelength. The light from each unit cell can be coupled into a common bus waveguide for downstream use. For example, the optical memory bank may be implemented as an optical source that emits, from the common bus waveguide, light at a plurality of different wavelengths. In an example, an optical memory bank according to the present disclosure may be used to replace comb lasers, thereby providing reduced energy consumption relative to energy consumed by convention comb lasers. Furthermore, each wavelength emitted by a respective optical device can be finely tuned to any desired wavelength, for example, based on the structure of the unit cell, physical characteristics thereof, and tuning of the first voltage bias. In contrast, line spacing between wavelengths emitted by conventional comb lasers can be fixed. Thus, the examples herein can provide for tunable optical sources that provide flexibility and variation in applications.

As used herein, the term “permanently” means that a state lasts or remains unchanged indefinitely, without interruption, under certain conditions. When the conditions change, the state may change. For example, as described above, the first voltage bias may change a condition of the non-volatile memory device to cause an accumulation of trapped carriers. When the first voltage bias is removed, the trapped carriers remain trapped permanently until the conditions change. For example, applying a second voltage bias (e.g., the reset voltage bias) changes the conditions applied to the non-volatile memory such that the trapped carriers can be released, thereby changing the state of the non-volatile memory device under altered conditions.

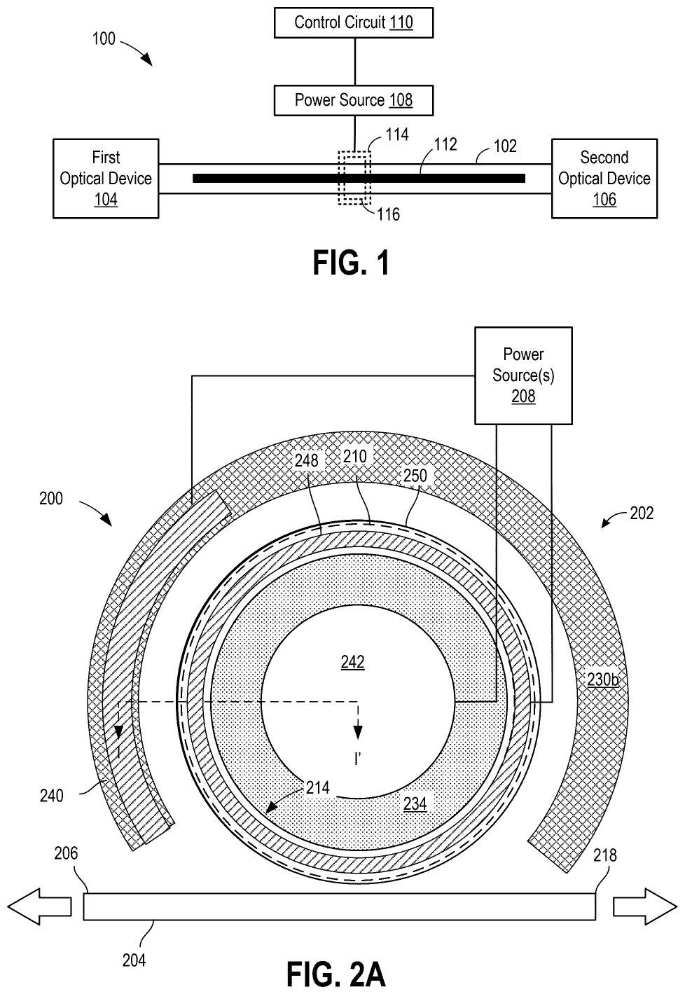

FIG. 1 illustrates an example optical system 100 in accordance with examples of the present disclosure. The optical system 100 may include a plurality of optical devices capable of generating, processing, and/or allowing passage of an optical signal (e.g., light). In the example of FIG. 1, the optical system 100 includes a light-conducting medium 102, a first optical device 104, a second optical device 106, one or more power source 108, and a control circuit 110. The optical system 100 may include an optical memory device (also referred to as an optical device) in the form of light-conducting medium 102.

The light-conducting medium 102 comprises an optical waveguide such as a semiconductor waveguide. The first optical device 104 comprises an optical device capable of generating and/or processing optical signals. Examples of the first optical device 104 may include, but are not limited to, a light source, an optical amplifier, an optical modulator, an optical splitter, an optical combiner, an optical coupler, an optical filter, an optical resonator, or a photodetector. Furthermore, the second optical device 106 may comprise an optical device capable of generating and/or processing the optical signals. Examples of the second optical device 106 may include, but are not limited to, an optical amplifier, an optical modulator, an optical splitter, an optical combiner, an optical coupler, an optical filter, an optical resonator, or a photodetector.

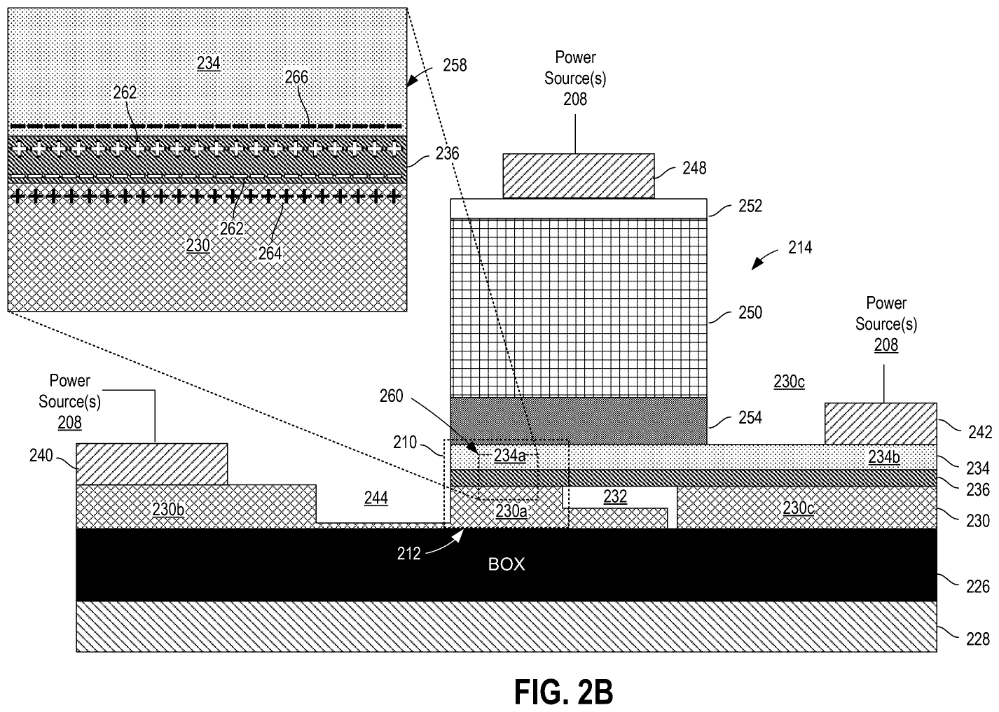

In the example implementation of FIG. 1, the light-conducting medium 102 is shown to include a capacitive structure 112. In some examples, the capacitive structure 112 may be a MOSCAP formed within the structures of the light-conducting medium 102 (e.g., integrated therein). An example of the capacitive structure 112 as a MOSCAP is provided below in connection with FIGS. 2A and 2B.

In examples, the capacitive structure 112 may aid in the generation of light within the light-conducting medium 102. For example, the capacitive structure 112 may be integrated with light emitting device 114 in the structure of the light-conducting medium 102. The light emitting device 114 can be configured for generation and emission of light, which can be injected or otherwise coupled into the light-conducting medium 102. For example, the light emitting device 114 may comprise an optically active medium formed in the structures of the light-conducting medium 102. Application of a voltage bias (e.g., a seed voltage bias) across the optically active medium via the capacitive structure 112 may cause an accumulation of free charge carriers that may lead to stimulated emission within the optically active medium. This stimulated emission may function as a seed signal that stimulates further emissions causing the generation of light. The generated light may be injected (e.g., emitted) into the optical waveguide of the light-conducting medium 102. The light may then propagate along the optical waveguide to the first optical device 104, the second optical device 106, or both. For example, the first optical device 104 may be a bus waveguide that functions to couple light propagating along light-conducting medium 102 into the bus waveguide for output to a subsequent optical device (e.g., another waveguide, an optical amplifier, an optical modulator, an optical splitter, an optical combiner, an optical coupler, an optical filter, an optical resonator, a photodetector, etc.). Similarly, light propagating along light-conducting medium 102 may be received by the second optical device 106.

The capacitive structure 112 may further aid in non-volatile tuning of a wavelength of light propagating in the light-conducting medium 102. For example, the light emitting device 114 may generate light at a first wavelength and a non-volatile memory device 116, formed in the structures of the light-conducting medium 102, may operate to tune the wavelength to a second wavelength. In an illustrative example, the capacitive structure 112 may include defect sites that result in carrier traps (see FIG. 2B). Application of a first voltage bias across the capacitive structure 112 may cause the generation of free charge carriers that can be trapped in the carrier traps. The trapped carriers may exhibit non-volatility such that the carriers remain permanently trapped in the absence of the first voltage bias. The accumulation of trapped carriers may result in a change (e.g., increase) in the refractive index of the light-conducting medium 102 due to a plasma dispersion effect. The change in the refractive index may cause variations the wavelengths of light that can be carried by the light-conducting medium 102, which results in a non-volatile tuning of the wavelength of light propagating therein.

While the example of FIG. 1 depicts the capacitive structure 112, the light emitting device 114, and the non-volatile memory device 116 as rectangular boxes, these representations are for illustrative purposes only. The rectangular boxes are intended as schematic representations of more complex structures, examples of which are provided below in connection with FIGS. 2A and 2B.

FIGS. 2A and 2B depict a schematic diagram of an example optical system 200 in accordance with an illustrative implementation of the present disclosure. FIG. 2A illustrates a top down view of the example system 200 and FIG. 2B illustrates a cross system view of the optical system 200 taken along the line I-I′ shown in FIG. 2A. The optical system 200 may be an example of the optical system 100 of FIG. 1. The optical system 200 may be an example of the optical system 100 of FIG. 1.

In the example, the optical system 200 comprises an optical device (also referred to as an optical memory device) as a resonator structure 202 optically coupled to a bus waveguide 204. The resonator structure 202 may be an example of the light-conducting medium 102 of FIG. 1. The bus waveguide 204, in some examples, may be an example of the first or second optical device 104 and 106. In some examples, port 206 and/or port 218 of the bus waveguide 204 may be optically coupled to downstream optical devices, such as, but not limited to, a light source, an optical amplifier, an optical modulator, an optical splitter, an optical combiner, an optical coupler, an optical filter, an optical resonator, a waveguide, or a photodetector. According to examples, each of port 206 and port 218 may function as an input port to receive optical signals from an upstream optical device or as an output port to supply an optical signal to a downstream optical device.

In the example of FIGS. 2A and 2B, the resonator structure 202 includes an optical waveguide 210 that can be optically coupled to the bus waveguide 204 via an optical coupler (not shown). The resonator structure 202 also comprises a mesa structure 214 formed on an integrated capacitive structure 212 (e.g., an example implementation of capacitive structure 112 of FIG. 1). The capacitive structure 212 (also sometimes referred to herein as a capacitor) may aid in the generation of light within the resonator structure 202, as well as the aiding in non-volatile tuning of the wavelength of this light. In some examples, some or all of the elements of the optical system 200 may be part of a PIC, for example, the resonator structure 202 may comprise components formed of silica, silicon, or other Group IV material (e.g., germanium, silicon carbide, silicon germanium, and so on).

The resonator structure 202 may be a closed loop waveguide 210 formed of semiconductor material, such as silicon or other Group IV material. The shape of the loop may be, for example but not limited to, circular, elliptical, a racetrack shape, etc., thereby forming a ring resonator (e.g., a micro-ring resonator structure as shown in FIG. 2A). The resonator structure 202 may have a resonant frequency at which light propagates within the optical waveguide 210. The light propagating in the optical waveguide 210 can be evanescently coupled into (and/or out of) the bus waveguide 204 via the optical coupler according to a coupling coefficient.

The optical system 200, according to various implementations, can be configured for self-seeding (or self-injection locking) at a first wavelength of light generated by an optically active medium 254 of a mesa structure 214, as described below in connection with FIG. 2B. The mesa structure 214 may be an example of light emitting device 114 of FIG. 1. For example, the mesa structure 214 may, in self-seeding implementations, be operated to cause an optically active medium 254 to generate light that can be injected into the optical waveguide 210 at the resonant frequency (e.g., first wavelength). As light resonating within the optical waveguide 210 may function as a seed signal that stimulates additional emissions at the wavelength of the seed signal (e.g., akin to an optical feedback). According to various illustrative implementations, the optically active medium 254 may include, but are not limited to, quantum dots (QD), quantum wells (QW), quantum-dash structures, or any structure that can create carrier population inversion for optical emissions in the waveguide. In these implementations, the light can be generated when a voltage bias (e.g., a seed voltage bias) is applied to the optically active medium 254 across the mesa structure 214, thereby stimulating emission (e.g., photoluminescence), for example in the case of quantum dots, by the optically active medium at a wavelength corresponding to the energy difference between conductance band and valence band or the transition between discretized energy states.

Self-seeding techniques can result in linewidths that are narrower than those compared with injection locked lasers, which rely on external sources as seed signals. The linewidth indicates the purity of frequency in light. A narrow linewidth is not a direct measure or indicator of the physical width of the light (the same as the visual or geometric diameter of light projected on a surface), but rather, an indicator of what proportion of the light is composed of a single frequency or wavelength. Thus, implementations herein are able to provide a narrower linewidth than conventional optical memory devices through self-seeding techniques.

While the above examples are provided with reference to self-seeding approach, the optical system 200 may be configured for injection locking at the first wavelength, for example, generated by an external optical source received via one of ports 206 or 218 and coupled into the resonator structure 202. The received light may function as a seed signal for optical amplification, which causes the light emitting device to emit additional light at the frequency of the seed signal, thereby providing optical gain that amplifies the light propagating in the optical waveguide 210.

In examples, the capacitive structure 212 (which is hidden in view of FIG. 2A by the mesa structure 214) may be operated to provide non-volatile wavelength tuning, for example, as an example implementation of non-volatile memory device 116 of FIG. 1. For example, the capacitive structure 212 may be configured to tune a wavelength of light generated by the mesa structure 214 from the first wavelength to a second wavelength by utilizing a non-volatile memory device, as described below in connection with FIG. 2B. For example, the capacitive structure 212 may include an insulating interface (e.g., dielectric layer 236) that comprises one or more defect sites (see FIG. 2B) that cause trap regions to develop that can trap or otherwise store carriers (e.g., electrons or holes) in the insulating interface. Applying a first voltage bias (e.g., a set voltage bias) across the capacitive structure 212 may cause an increase in the concentration of free charge carriers in the resonator structure 202 at a boundary of insulating interface due to carrier accumulation. This increased concentration can lead to increasing numbers of free charge carriers being trapped in the trap regions. The accumulation of trapped carriers within the insulating interface, which can remain stored in the insulating interface once the first voltage bias is removed, cause a non-volatile plasma dispersion effect that permanently (e.g., until the reset voltage bias is applied) alters the refractive index of the optical waveguide 210. The change in refractive index of the optical waveguide 210 induces a change in the resonance frequency of the resonator structure 202. The change in the resonance frequency likewise induces a change in the wavelength of light that can propagate within the resonator structure 202, thereby forcing a change in the wavelength of the light. As a result, the wavelength of the light coupled into the bus waveguide 204 can be tuned to the second wavelength.

Additional details of the example optical system 200 will be provided below. In various examples, a buried oxide (BOX) layer 226 is grown on a substrate 228, which may be provided as silicon. In an example, BOX layer 226 may comprise silicon dioxide (SiO₂). Other examples of materials for BOX layer 226 may include, but are not limited to, Silicon Nitride (Si₃N₄), Aluminum oxide (Al₂O₃), Hafnium Dioxide (HfO₂), diamond, silicon carbide (SiC), or combinations thereof. A first semiconductor layer 230 (referred to herein as a device layer 230) can be formed on the BOX layer 226.

The device layer 230 may comprise a first semiconductor material, such as but not limited to, silicon or other Group IV material (e.g., germanium, silicon carbide, silicon germanium, and so on). In some examples, the device layer 230 may be doped with a dopant of a first polarity. For example, the device layer may comprise positive dopants to provide a positively-doped semiconductor material (e.g., a p-type doped semiconductor layer). The device layer 230 may be formed by deposition, wafer bonding, monolithic growth, or other fabrication techniques. The device layer 230 may comprise a first portion 230a, a second portion 230b, and a third portion 230c. In some examples, the second portion 230b may be heavily doped such that the second portion 230b has a free charge carrier concentration that is higher than the first portion 230a.

Trenches 232 and 244 may be formed in the device layer 230 to separate portions 230b and 230c from portion 230a. Trenches 232 and 244 may be air gaps formed by etching or otherwise removing material from the device layer 230 according to known techniques. A narrow portion of material may remain in each trench 244 and 232 as shown in FIG. 2B; however, such configuration is optional and may be removed to expose the BOX layer 226.

A second semiconductor layer 234 may be formed on the device layer 230.

The second semiconductor layer 234 may comprise a second semiconductor material that is dissimilar from the first material. For example, the second semiconductor layer 234 may comprise a Group III-V material, such as, but not limited to, indium phosphide (InP), gallium arsenide (GaAS) or other compounds of indium, gallium, phosphorus, and arsenic. In some examples, the second semiconductor layer 234 may be doped with a dopant of a second polarity. For example, the device layer may comprise negative dopants to provide a negatively-doped semiconductor material (e.g., an n-type doped semiconductor layer). The second semiconductor layer 234 may comprise a first portion 234a and a second portion 234b. In some examples, the second portion 234b may be heavily doped such that the second portion 234b has a free charge carrier concentration that is higher than the first portion 234a. The third portion 230c of device layer 230 may operate as a support structure formed between BOX layer 226 and the second portion 234b.

An insulating interface may be formed from a dielectric layer 236 between the device layer 230 and the second semiconductor layer 234. The dielectric layer 236 may be an electrically insulating material formed between the device layer 230 and the second semiconductor layer 234. The dielectric layer 236 can be native oxides of the cathode or the anode or both, or external dielectric materials such as high-k dielectrics or polymers that can be formed by deposition, oxidation, wafer bonding or other dielectric coating methods. In other examples, dielectric layer 236 may be formed from SiO₂, Si₃N₄, Al₂O₃, polyimides, transition metal oxides (e.g., HfO₂, titanium dioxide, zinc oxide, nickel oxide, etc.), organic materials, chalcogenides, 2D materials (e.g., molybdenum disulfide and the like), and ferroelectric materials, among others.

In examples, the dielectric layer 236 is formed at the boundary between the second semiconductor layer 234 and underlying portions of the device layer 230. A thin layer (e.g., on the order of tens of nanometers or less) of oxides of the second material (e.g., Group III-V oxides in an example) and oxides of the first material (e.g., silicon oxides in an example) may be provided between the second semiconductor layer 234 and underlying portions of the device layer 230, from which dielectric layer 236 forms naturally at this boundary and serves as a dielectric for the capacitive structure 212. In some examples, this thin layer has a thickness on a nanoscale, for example, a few nanometers thick. In some examples, steps need not be taken to encourage the formation of dielectric layer 236. In other examples, the formation of dielectric layer 236 may be stimulated, for example by elevating the temperature, exposing the materials to an oxygen-rich atmosphere, or other suitable technique.

Accordingly, the capacitive structure 212 can be defined between the first portion 230a of the device layer 230 and the first portion 234a of the second semiconductor layer 234 with the dielectric layer 236 acting as an insulator therebetween. In any case, the second portion 230b of the device layer 230 may be considered a first anode (e.g., where the device layer 230 is p-type doped) forming an electrical connection with the capacitive structure via the first portion 230a of the device layer 230, while the second portion 234b of the second semiconductor layer 234 may be considered a second portion 234b forming an electrical connection with the capacitive structure via the first portion 234a. In the case where the second material is a Group III-V material and the first material is silicon, the capacitive structure 212 may be a MOSCAP.

In the example shown in FIG. 2B, the dielectric layer 236 is formed continuously so as to overlap with the trench 232. In another example, the dielectric layer 236 may not be present within trench 232. In this case, two dielectric layers may be formed corresponding to the interface between the first portions 234a and 230a and the interface between the second portion 234b and the third portion 230c.

In the example of FIGS. 2A and 2B, the optical waveguide 210 is formed from the first portion 230a of the device layer and the first portion 234a of the second semiconductor layer 234, including the portion of dielectric layer 236 therebetween. Accordingly, the waveguide 210 includes the capacitive structure 212, such that second portion 230b electrically connects to the second portion 234b within the optical waveguide 210.

The dielectric layer 236 may include one or more defect sites as depicted in enlarged view 258 of portion 260 the optical waveguide 210, shown in FIG. 2B. The term “defect sites” as used herein may refer to imperfections in the bulk of the material of the insulating layer, surface imperfections at the boundaries of the insulating interface with other materials, or both. In some examples, the defect sites may be resulted from imperfections in the manufacturing process as well as intentionally created. The existence of the defect sites may cause the generation of trap regions 262 that can trap free charge carriers, such holes 264 and electrons 266. The refractive index of the optical waveguide 210 can depend on the amount of the free charge carriers at this interface, such that a change in the concentration of free charge carriers in the optical waveguide 210 can cause a change in the refractive index, as described below.

In examples, the first material may be a crystalline semiconductor material (e.g., crystalline silicon) and the second material may be a crystalline semiconductor material (e.g., crystalline Group III-V material). The dielectric layer 236 may be an amorphous material (e.g., amorphous Al₂O₃). As a result, defect sites are formed due to the imperfect interface between the crystalline semiconductor material and amorphous semiconductor material that generate dangling bond carrier traps. These dangling bond carrier traps can serve to alter the carrier concentration within the waveguide 210 and induce non-volatile plasma dispersion based wavelength shifts, as described herein.

In the example of FIGS. 2A and 2B, a contact electrode 240 may be disposed on the second portion 230b and a contact electrode 242 may be disposed on the second portion 234b. When a voltage bias is applied to electrodes 240 and 242, free charge carrier accumulation or depletion can occur at the boundaries of the dielectric layer 236, as described in greater detail below. Due to the optical waveguide 210 overlapping with a region of capacitive structure 212, carrier concentration change may lead to changes in waveguide refractive index. As shown in the example of FIG. 2B, an entire cross-section of the optical waveguide 210, taken along line I-I′ shown in FIG. 2A, is included within the capacitive structure 212. By biasing the voltage applied between the electrodes 240 and 242, the refractive index may be altered accordingly, thereby shifting of wavelength carried by the optical waveguide 210.

A mesa structure 214 can be formed on the second semiconductor layer 234 on a side of the dielectric layer 236 opposite the optical waveguide 210. For example, the mesa structure 214 can be formed on the first portion 234a so to overlap with the optical waveguide 210 in the longitudinal direction. The mesa structure 214 may include a third semiconductor layer 250 formed on the first portion 234a of the second semiconductor layer 234. The third semiconductor layer 250 may comprise a third semiconductor material that is doped with a polarity opposite to the second semiconductor layer 234. For example, the third semiconductor layer 250 may be a positively-doped semiconductor material (e.g., a p-type doped semiconductor layer). The third material may comprise a Group III-V material, such as, but not limited to, indium phosphide (InP), gallium arsenide (GaAS) or other compounds of indium, gallium, phosphorus, and arsenic. The third material may be similar to the second material, except being oppositely doped.

The mesa structure 214 comprises an optically active medium 254 formed on the first portion 234a. The optically active medium 254 can be formed in the third semiconductor layer 250 adjacent to the second semiconductor layer 234. In some implementations, the optically active medium 254 may be grown in the third semiconductor layer 250, such that the layers are monolithic. The optically active medium 254 may comprise, for example, quantum dot (QD), quantum wells (QW), quantum-dash (QD) structures, or any structure that can create carrier population accumulation or depletion. In an example, the optically active medium 254 may comprise InAs and/or GaAs QDs.

An anode 252 (sometimes referred to as a second anode, e.g., where portion 230b is considered a first anode) may be formed in the third semiconductor layer 250 and an electrode 248 disposed thereon on a side of the optically active medium 254 opposite the dielectric layer 236. In some examples, the anode 252 may be a portion of the third semiconductor layer 250 that is heavily doped, for example, having the same doping polarity as third semiconductor layer 250 but a higher concentration of dopants than the rest of third semiconductor layer 250.

The mesa structure 214 can be formed to generate light, which can be coupled into the optical waveguide 210 by traversing the intervening layers. For example, a seed voltage bias can be applied across the mesa structure 214 via contact electrodes 242 and 248. Thus, the seed voltage bias is applied to optically active medium 254, which stimulates light emission at the resonant frequency. Due to the longitudinal overlap between mesa structure 214 and the optical waveguide 210, light generated by the mesa structure 214 can be coupled in the optical waveguide 210 by traversing the second semiconductor layer 234 and dielectric layer 236. The BOX layer 226, trench 232, and trench 244 may function to confine the light to the optical waveguide 210 in the lateral and longitudinal directions.

In an example, a forward voltage bias may be applied between the electrodes 248 and 242 (e.g., +V), for example, by the one or more power sources 208. The one or more power source 208 may be controlled by, for example, control circuit 110 of FIG. 1. The power sources 208 may act as a signal source and can include a negative terminal connected to the electrode 242 and a positive terminal connected the electrode 248. Applying the forward voltage bias can cause a carrier concentration change through accumulation that leads to stimulated emission in the optically active medium 254, thereby generating light. Emitted light traverses the layers and is injected into the optical waveguide 210 and resonators in the resonator structure 202. Accordingly, by biasing the voltage applied between the electrodes 242 and 252, a seed signal may be generated and provided to the optical waveguide 210 via mesa structure 214.

As alluded to above, a wavelength of light propagating in waveguide 210 (e.g., as generated by the mesa structure 214) can be altered due to refractive index changes induced by applying a first voltage bias to the capacitive structure 212. For example, power source(s) 208 may be connected to electrodes 242 and 240. Applying a reverse voltage bias (e.g., −V) results in a migration of negative charges from the second portion 234b toward the boundary the first portion 234a of the second semiconductor layer 234 adjacent to the dielectric layer 236 (e.g., within the optical waveguide 210). Additionally, positive charges (“holes”) migrate from the anode 230b to the boundary of the first portion 230a of the device layer 230 adjacent to the dielectric layer 236 (e.g., within the optical waveguide 210). This operation can be referred to as accumulation mode.

The migration of free charge carriers, e.g., holes and electrons, to the boundaries within the optical waveguide 210 can result in increased carrier concentrations at the interface with the dielectric layer 236. The increased concentrations can lead to an increasing number of free charge carriers being trapped in the trap regions 262 of the dielectric layer 236. The accumulation of trapped carriers, which remain trapped (e.g., stored) in the dielectric layer 236 even after the first voltage bias is removed, can cause a non-volatile plasma dispersion effect that permanently (e.g., until a reset voltage bias is applied) changes the refractive index of the optical waveguide 210. The change in refractive index induces a change in the resonance frequency of the resonator structure 202 that changes the wavelength of light propagating in the resonator structure 202.

For example, where dangling bond carrier traps exist due to the imperfect interface between crystalline and amorphous materials, as described above, electrons and holes can be trapped in the dangling bond carrier traps. In this instance, trapped electrons can attract holes towards an interface on the side of the dielectric layer 236 adjacent to the first portion 230a. Likewise, trapped holes can attract electrons towards the interface side of the dielectric layer 236 adjacent to the portion 234a. The combined trapping effects can result in the non-volatile plasma dispersion effect that permanently alters the refractive index of the particular region and provides for the non-volatile wavelength tuning. The trapping can be a transient behavior with set and reset voltage biases provided by the Heiman model. This transient behavior can be described by an occupation probability differential equation as shown in Equation 1.

$$\frac{d \text{?}}{dt} = {v}_{P}^{x} {σ}_{P}^{x} [ P ( 1 - \text{?} ) - \text{?} {n}_{i}^{x} exp ( \frac{\text{?} - {E}_{i}^{x}}{{k}_{B} T} ) ] - {v}_{N}^{x} {σ}_{N}^{x} [ N \text{?} - \frac{( 1 - \text{?} {n}_{i}^{x} )}{{F}_{deg}^{x}} exp ( \frac{{E}_{i}^{x} - \text{?}}{{k}_{B} T} ) ] , \qquad ( 1 )$$

$${σ}_{P}^{x} ( d ) = {σ}_{P}^{x} \text{?} , {σ}_{N}^{x} ( d ) = {σ}_{N}^{x} \text{?} , \qquad ( 2 )$$

$$\text{?} = \frac{2 {m}_{h}^{*} ( \text{?} - \text{?} )}{\text{?}} , \text{?} = \frac{2 \text{?} ( \text{?} - \text{?} )}{\text{?}} . \qquad ( 3 )$$

$$\text{?} \text{indicates text missing or illegible when filed}$$

where F_{tD}^{x}, v_{P}^{x}, and V_{N}^{x} represent carrier trap occupation probability, hole thermal velocity, and electron thermal velocity respectively; x represents the interface between the dielectric layer 236 and either the device layer 230 or the second semiconductor layer 234; σ_{P}^{x} and σ_{N}^{X}, defined by Equation 2, denote carrier trap cross-section for holes and electrons, respectively; P and N are the free hole and electron concentrations; F_{deg}^{x} is the degeneracy factor; and nᵢ^{x} is the intrinsic carrier concentration, E_{tD}^{x} and Eᵢ^{x} are the energy levels of the carrier traps and intrinsic energy levels.

The four terms on the right hand side of Equation 1 consists of four distinct rates: 1) a trapping rate by conduction band electrons, 2) a discharge rate to the conduction band, 3) a discharge rate due to valence band hole capture, and 4) a trapping rate due to emission of holes to the valence band. These rates depend linearly on the carrier trap cross-sections, and which rate dominates can be determined by the carrier surface densities. The carrier tunneling to trap states E^{x}_{tA} from the conduction band edge E^{x}_{c} can be modelled by the term with the electron evanescent wavevector Kₑ as shown in Equations 2 and 3. Likewise, tunneling from the valance band edge Eₓ^{v} to trap state E^{x}_{tA} occurs through the wavevector Kh. The mono-energetic trap density can be assumed to be uniform up to a specified depth d, and zero beyond that.

The trapped carriers can be released by applying a forward voltage bias across electrodes 242 and 240. For example, the forward voltage bias may cause a migration of negative charges from the optical waveguide 210 toward second portion 234b operating as a cathode, and migration of holes from the optical waveguide 210 toward first portion 230a, operating as an anode (e.g., referred to as depletion mode). This migration of free charge carriers away from the boundaries within the optical waveguide 210 can result in decreased carrier concentrations at the interface with the dielectric layer 236. The decreased concentrations can lead to an the release of free charge carriers from the trap regions 262, which changes the wavelength of light propagating in the resonator structure 202 back to the initial wavelength.

While certain materials are described as negatively- or positively-doped, implementations are not limited thereto, and the polarity doping may be switched. For example, while the above example described the second semiconductor layer 234 as negatively-doped and the device layer 230 as positively-doped, the polarity of each layer may be switched such that the second semiconductor layer 234 is positively-doped (e.g., providing an anode) and the device layer 230 may be negatively-doped. In this case, portion 234b may become an anode and portion 230b may become a cathode, and the polarity of the voltage bias may be reversed to achieve the above described functionality.

In a non-limiting example implementation, fabrication of the optical system 200 may start with a 100 mm silicon-on-insulator (SOI) wafer as substrate 228 and BOX layer 226, which may also include a 300 nm thick top silicon layer as an example of device layer 230. The optical waveguide 210 and bus waveguide 204 can be patterned from the device layer 230 using a deep-ultra-violet (UV) stepper and then etched with Cl₂ based gas chemistry. The dielectric layer 236 may be provided as 10 nm thick layers of Al₂O₃ deposited on an upper surface of the patterned device layer 230 and a surface of an approximately 200 nm thick Group III-V material epitaxial wafer (e.g., an example of the second semiconductor layer 234) via atomic layer deposition (ALD). The Group III-V material epitaxial wafer may include a 3 um wide Group III-V material epitaxial stack defined by the third semiconductor layer 250, the optically active medium 254, and the anode 252. The Group III-V material epitaxial stack can be then wafer-bonded onto the patterned silicon wafer with the Al₂O₃ layer provided therebetween, resulting in a 20 nm thick dielectric layer 236.

Continuing with the non-limiting example, the silicon waveguide (e.g., optical waveguide 210) can be defined by a width, height, and etch depth of 1.5 um, 300 nm, and 245 nm, respectively. In an example, the resonator structure 202 may have a silicon waveguide radius of 23.62 um. The wafer-bonded Group III-V epitaxial stack may include a P—N epitaxial stack (e.g., the third semiconductor layer 250 and the anode 252). The optically active medium 254 may be between 100 nm and 500 nm thick and can be defined by multiple-quantum wells (MQW), which includes size compressively strained (+0.8%) In_{0.86}Ga_{0.14}As_{0.55}P_{0.45} layers surrounded by seven tensile strained (−0.19%) In_{0.84}Ga_{0.16}As_{0.29}P_{0.71} layers. An electron stop layer (In_{0.5}Al_{0.5}As) can be used above the MQW region for improved thermal performance. The third semiconductor layer 250 may include a 1.5 μm thick p-InP followed by a 200 nm p-doped In_{0.53}Ga_{0.47}As as the anode 252. A full silicon etch can be partially used underneath the n-InP region such that there is electrical isolation between the n-doped second semiconductor layer 234 and the p-doped device layer 230.

While the above examples provides specific parameters for the optical system 200, these parameters are provided merely as an example. An optical system 200 may be fabricated having different parameters as desired for a particular application. For example, the dielectric layer 326 may have a thickness of 5 nm, 10 nm, 15 nm, 25 nm, etc.

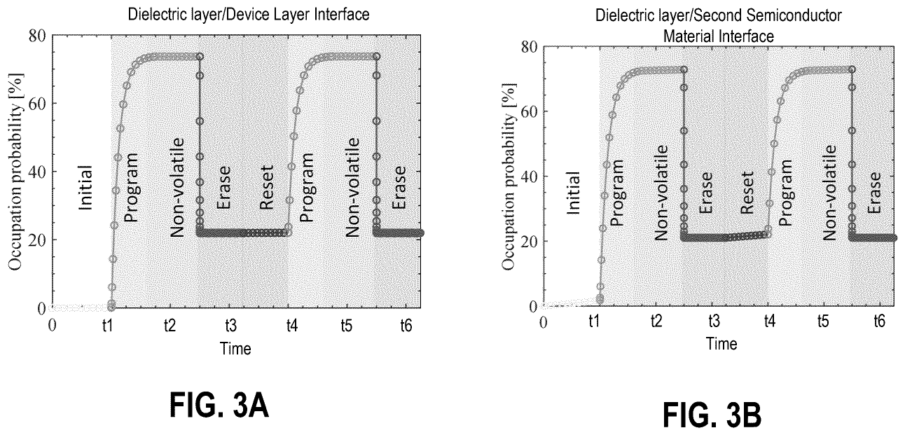

FIGS. 3A and 3B show example carrier-trap occupation probabilities for the interface between the dielectric layer 236 and the device layer 230 (FIG. 3A) and the interface between the dielectric layer 236 and the second semiconductor layer 234 (FIG. 3B). Without any bias, the ‘initial’ state may a value of zero occupation probability. After setting with a first voltage bias of sufficient time duration, the occupation probability reaches a saturated value that becomes the on-set of non-volatility. By tuning off the bias, a permanent occupation probability exists over time, indicating non-volatility. Erasure of this non-volatile state can be achieved by applying a bias of opposite polarity to sweep out (e.g., release) trapped carriers.

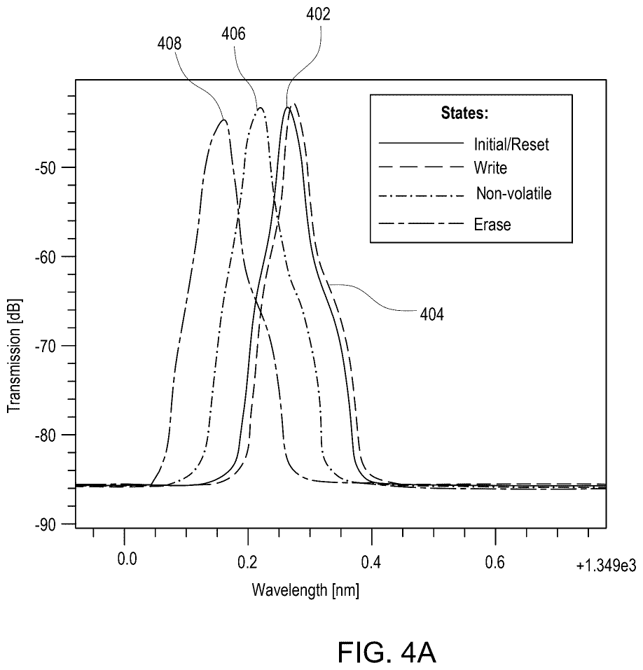

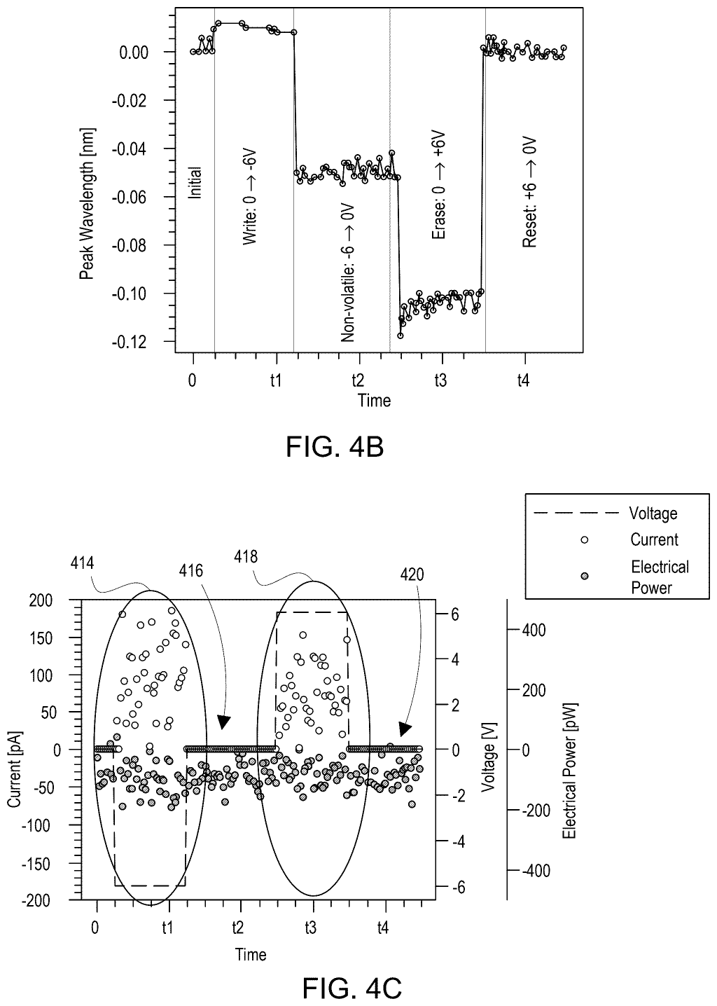

FIGS. 4A-4C illustrates examples of non-volatile wavelength shifts provided by the examples disclosed herein. FIG. 4A depicts an example of peak wavelength spectrums at various states according to an example implementation of the optical system 200. FIG. 4B depicts peak wavelengths as a function of time under certain biasing conditions of initial conditions, programming conditions (e.g., write), storage conditions (e.g., non-volatile), erase conditions, and reset. FIG. 4C depicts power consumption during each biasing condition above.

An initial state may refer to the state of the optical system (e.g., optical system 200) prior to any biasing being applied. This state may be achieved immediately following fabrication. As shown in FIGS. 4A-4B, an initial peak wavelength (e.g., an example of a first wavelength) of optical spectrum 402 is achieved prior to any voltage bias applied. In the example of FIGS. 4A-4B, the initial peak wavelength of optical spectrum 402 is shown as 1349.277 nm. To initiate programming/write, a reverse voltage bias of 6V (e.g., an example of a first or set voltage bias in accordance with this example) is applied (0→−6 V in FIG. 4B), which changes the optical spectrum to optical spectrum 404 and consumes current and electrical power 414 (FIG. 4C). In the example of FIGS. 4A-4B, the peak wavelength of optical spectrum 404 is shown as 1349.282 nm. After a hold time, the reverse voltage bias is turned off (−6→0V in FIG. 4B), the optical spectrum shifts to optical spectrum 406 having a peak wavelength (e.g., an example of the second wavelength described above). The shift to optical spectrum 406 is non-volatile, thereby consuming no additional power 416 (FIG. 4C). In the example of FIGS. 4A-4B, the peak wavelength of optical spectrum 406 is shown as 1349.217 nm (e.g., a 60 pm shift in peak wavelength). Subsequently, an erasure operation can be performed by applying a forward voltage bias (0→+6V in FIG. 4B) that consumes power and current 418 (FIG. 4C), which causes the optical spectrum to shift to optical spectrum 408. This forward voltage bias is an example of a second or reset voltage bias in accordance with this example. In the example of FIGS. 4A-4B, the peak wavelength of optical spectrum 408 is shown as 1349.153 nm. After a hold time, the forward voltage bias is removed (+6V→0 in FIG. 4B), thereby consuming no additional power 420 (FIG. 4C) and resetting the optical spectrum to optical spectrum 402. This reset state (e.g., optical spectrum 402) overlaps with the initial state, which indicates a successful reset of the non-volatile state (e.g., optical spectrum 406) back to the initial state (e.g., optical spectrum 402).

While the above describe provides certain specific examples of peak wavelengths for various states of the disclosed technology, it will be appreciated that the scope of the present disclosure is not limited to these specific examples. Other peak wavelengths may be realized depending on the physical parameters and voltage biases applied to a specific implementation. For example, in another implementation the peak wavelength of an optical spectrum of an initial state may be 1348.545 nm and the peak wavelength of an optical spectrum of a non-volatile state may be 1348.4647 nm, realizing an approximately 80 pm blue-shift in the optical spectrum.

The examples disclosed here, such as optical system 100 and/or 200 described above, can be operated to realize non-volatile wavelength shifts to one of a plurality of different wavelengths by adjusting the first voltage bias to different bias levels. In this instance, each bias level may result in a respective change in the refractive index of the optical waveguide, resulting tuning to a respective wavelength of light. For example, a first voltage bias at a first bias level may tune the light emitted by the light emitting device to the second wavelength. Tuning the first voltage bias to a second bias level may tune the light emitted by the light emitting device to a third wavelength. A third bias level may result in a fourth wavelength, and so on. Each bias level may correspond to a concentration of accumulated trapped carriers that triggers a respective plasma dispersion effect to provide for non-volatile wavelength shifts. Said another way, at voltage biases between each bias level, any refractive index change may be volatile. Non-volatile states are not triggered until the concentration of accumulated trapped carriers reaches specific thresholds, which are based on the structural properties of the devices and materials used to fabricate the device. At each threshold bias level, the disclosed examples accumulate sufficient trapped carriers that induce a non-volatile wavelength shift, as discussed above. Thus, the optical systems disclosed herein can be programmed (e.g., set) to a number of different states, represented as different wavelengths, through selective tuning of the first voltage bias.

As an illustrative example, a first wavelength of an initial state (e.g., a first voltage bias of 0 V) may be 1348.545 nm. A first voltage bias at a first bias level of −2 V may tune the light emitted by the light emitting device, in a non-volatile state, to a wavelength of 1348.5205 nm. Tuning the first voltage bias to a second bias level of −4 V may tune the light emitted by the light emitting device, in a non-volatile state, to a wavelength of 1348.4934 nm. A third bias level of −6 V may result in a wavelength shift to 1348.4647 nm.

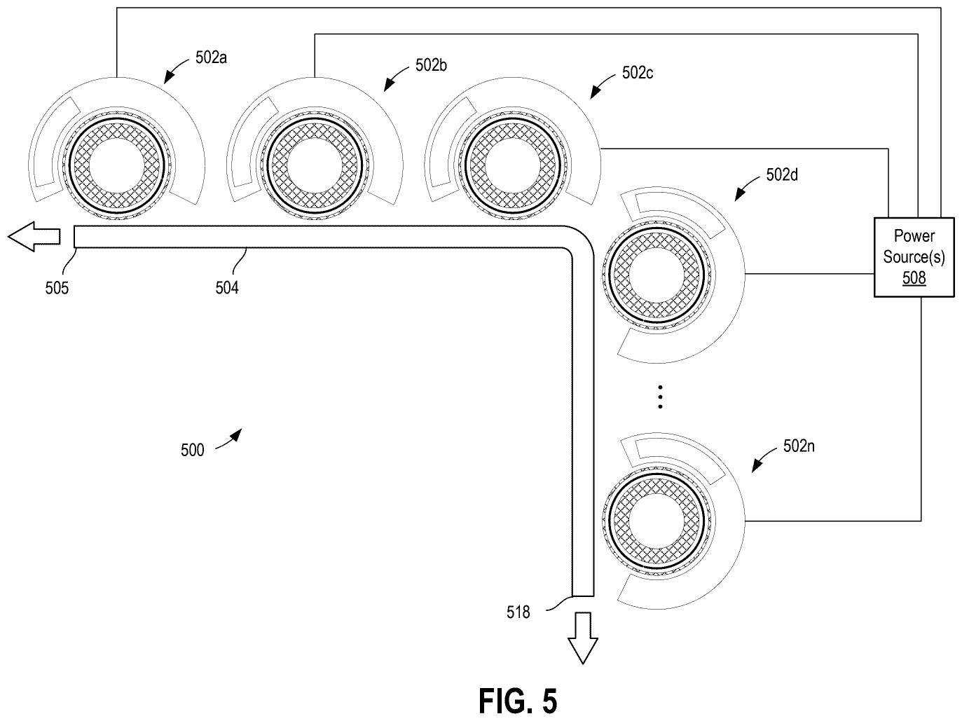

FIG. 5 is a schematic diagram of an optical memory bank 500 in accordance with examples disclosed herein. The optical memory bank 500 comprises a plurality of unit cells 502a-502n arranged in an array (e.g., a 1 by N array in this example) and coupled to a common bus waveguide 504 (e.g., an example of bus waveguide 204). One or more of the plurality of unit cells 502a-502n may be implemented as a respective instance of resonator structure 202. As such, each unit cell 502a-502n may be configured to generate light at a first wavelength based on a respective seed voltage bias from one or more power source 508 (e.g., an example implementation of power source 108 and/or power source(s) 208), as described above in connection with FIGS. 1-4C. Additionally, each unit cell 502a-502n may be configured for non-volatile wavelength tuning based on a set and/or reset voltage bias from one or more power source 508, as described above in connection with FIGS. 1-4C.

Each unit cell 502a-502n can be configured to evanescently coupled light emitted therefrom into the common bus waveguide. Port 506 and/or 518 of the bus waveguide 504 may be optically coupled to downstream optical devices, such as, but not limited to, a light source, an optical amplifier, an optical modulator, an optical splitter, an optical combiner, an optical coupler, an optical filter, an optical resonator, a waveguide, or a photodetector. According to examples, each of port 506 and port 518 may function as an input port to receive optical signals from an upstream optical device or as an output port to supply an optical signal to a downstream optical device.

In an example, each unit cell 502a-502n may be tuned to a different wavelength through application of a respectively different bias level as respective first voltage levels, resulting in light emitted by each unit cell 502a-502n at a respective wavelength according the bias level, as described above. In some examples, each unit cell 502a-502n may be substantially similar and fabricated according to substantially similar processes.

In examples, the optical memory bank 500 may be implemented as an optical source that emits, from the common bus waveguide 504, light at a plurality of different wavelengths. In an example, an optical memory bank 500 according to the present disclosure may be used to replace comb lasers, thereby providing reduced energy consumption relative to energy consumed by conventional comb lasers.

Furthermore, each wavelength emitted by a respective unit cell 502a-502n can be finely tuned to a desired wavelength, for example, based on structure of the respective unit cell, physical characteristics thereof, and tuning of the first voltage bias.

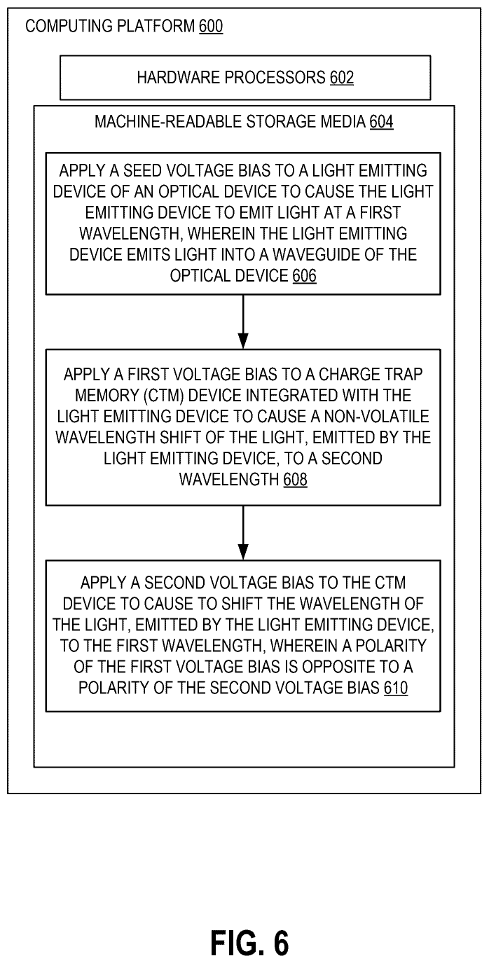

FIG. 6 illustrates a computing component that may be used to implement non-volatile optical memory in accordance with various examples of the disclosed technology. Referring now to FIG. 6, computing component 600 may be, for example, a server computer, a controller, or any other similar computing component capable of processing data. In the example implementation of FIG. 6, the computing component 600 includes a hardware processor 602, and machine-readable storage medium 604.

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606-610, to control processes or operations non-volatile optical memory. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 604 may be a non-transitory storage medium, where the term “non-transitory” does not encompass transitory propagating signals. As described in detail below, machine-readable storage medium 604 may be encoded with executable instructions, for example, instructions 606-610.

Hardware processor 602 may execute instruction 606 to apply a seed voltage bias to a light emitting device of an optical device to cause the light emitting device to emit light at a first wavelength. The light emitting device may emit light into a waveguide of the optical device. For example, the optical device may be example optical system 100 and/or optical system 200. As described above, the optical device may comprise a capacitive structure (e.g., capacitive structure 112 and/or capacitive structure 212) that may aid in the generation of light, for example, by applying a seed voltage bias, as described above in connection with FIGS. 1-5. Instructions 606 may provide a control signal to a power source (e.g., power source 108 and/or power sources 208) that causes the power source to apply the seed voltage bias. In examples, the light emitting device may inject the light into the optical waveguide (e.g., light-conducting medium 102 and/or optical waveguide 210 of resonator structure 202) by traversing intermediate layers between optical waveguide and the light-emitting device. The first wavelength of the light may be based on the designed structures and materials comprising the optical device, such as the optically active medium 254.

Hardware processor 602 may execute instruction 608 to apply a first voltage bias to a CTM device integrated with the light emitting device to cause a non-volatile wavelength shift of the light, emitted by the light emitting device, to a second wavelength. The CTM device and the light emitting device are formed in the waveguide, for example, as described in connection with FIGS. 1-2B. For example, the capacitive structure (e.g., capacitive structure 112 and/or capacitive structure 212) may aid in non-volatile tuning of the wavelength of light emitted by the light emitting device, for example, by applying a first voltage bias, as described above in connection with FIGS. 1-5. Instructions 608 may provide a control signal to the power source that causes the power source to apply the first voltage bias (e.g., a reverse voltage bias) that causes an accumulation of trapped free charge carriers within the CTM device, and ultimately within the optical waveguide. The traps carriers induce a change in the refractive index that causes a shift in the wavelength of light propagating on the optical waveguide, as described above.

Hardware processor 602 may execute instruction 610 to apply a second voltage bias to the CTM device to cause to shift the wavelength of the light to the first wavelength. The polarity of the second voltage bias is opposite to the polarity of the first voltage bias. For example, instructions 610 may provide a control signal to the power source that causes the power source to apply the first voltage bias (e.g., a reverse voltage bias) that causes a release of the trapped carriers, which redistributes the free charge carriers within the optical waveguide. The redistribution of the free charge carriers causes the refractive index of the optical waveguide to revert to its initial state and the wavelength of light on the optical waveguide returns to the first wavelength.

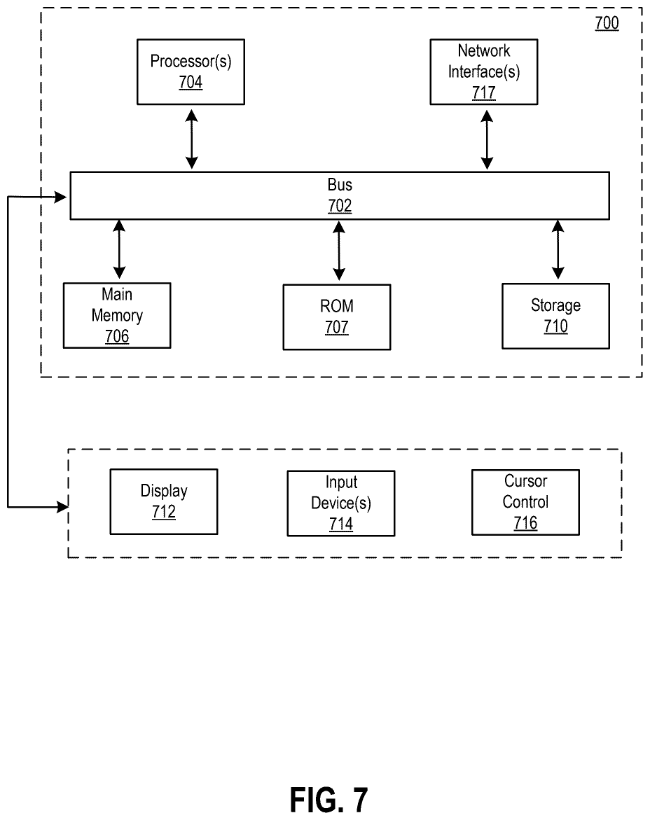

FIG. 7 depicts a block diagram of an example computer system 700 in which various examples of the disclosed technology described herein may be implemented. The computer system 700 includes a bus 702 or other communication mechanism for communicating information, one or more hardware processors 704 coupled with bus 702 for processing information. Hardware processor(s) 704 may be, for example, one or more general purpose microprocessors. The computer system 700 may be implemented as one or more components of the optical systems described in connection with FIGS. 1-2B and 5, for example, as the control circuit 110.

The computer system 700 also includes a main memory 706, such as a random access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions. For example, main memory 706 may store instructions, that when executed by processor(s) 704, cause computer system 700 to perform one or more of the operations described in connection with FIG. 6.

The computer system 700 further includes a read only memory (ROM) 708 or other static storage device coupled to bus 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. In some examples, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one example of the disclosed technology, the techniques herein are performed by computer system 700 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 710. Volatile media includes dynamic memory, such as main memory 706. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 702. Transmission media can also take the form of acoustic or light waves, such as those generated during radio-wave and infra-red data communications.

The computer system 700 also includes a network interface 718 (also referred to as a communication interface) coupled to bus 702. Network interface 718 provides a two-way data communication coupling to one or more network links that are connected to one or more local networks. For example, network interface 718 may be an integrated services digital network (ISDN) card, cable modem, satellite modem, or a modem to provide a data communication connection to a corresponding type of telephone line. As another example, network interface 718 may be a local area network (LAN) card to provide a data communication connection to a compatible LAN (or WAN component to communicate with a WAN). Wireless links may also be implemented. In any such implementation, network interface 718 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through network interface 718, which carry the digital data to and from computer system 700, are example forms of transmission media.

The computer system 700 can send messages and receive data, including program code, through the network(s), network link and network interface 718. In the Internet example, a server might transmit a requested code for an application program through the Internet, the ISP, the local network and the network interface 718.

The received code may be executed by processor 704 as it is received, and/or stored in storage device 710, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An optical device comprising:
a light emitting device disposed on a substrate, the first light emitting device including a first semiconductor layer disposed on a first side of a dielectric layer and on a first portion of a second semiconductor layer, wherein the second semiconductor layer is disposed on a second side of the dielectric layer, wherein the light emitting device emits light into a waveguide comprising the first portion of the second semiconductor layer;
a non-volatile memory device integrated with the first light emitting device, wherein the non-volatile memory device includes the first portion of the second semiconductor layer, the dielectric layer, and the first semiconductor layer;
one or more power sources configured to:
apply a seed voltage to the first semiconductor layer to cause the light emitting device to emit light at a first wavelength; and
apply a first voltage bias across the first portion of the second semiconductor layer and the second semiconductor layer to tune a wavelength of the light, emitted by the light emitting device, to a second wavelength.

2. The optical device of claim 1, further comprising:
a bus waveguide optically coupled to the light emitting device, wherein the light at the second wavelength is optically coupled into the bus waveguide.

3. The optical device of claim 2, wherein, after applying the first voltage bias, the one or more power sources are configured to apply a second voltage bias across the first portion of the second semiconductor layer and the second semiconductor layer to tune the wavelength of the light to the first wavelength.

4. The optical device of claim 2, further comprising:
a resonator structure formed on the substrate, wherein the resonator structure comprises the waveguide comprising the first portion of the second semiconductor layer, wherein the dielectric layer and the second semiconductor layer are provided in the waveguide.

5. The optical device of claim 4, wherein the resonator structure is a micro-ring resonator and wherein the light emitting device is a micro-ring resonator laser.

6. The optical device of claim 1, wherein the one or more power sources are configured to apply the first voltage bias as a plurality of voltage biases levels that tunes the wavelength of the light, emitted by the light emitting device, to a plurality of wavelengths.

7. The optical device of claim 1, wherein the non-volatile memory device is a charge-trap memory device.

8. The optical device of claim 7, wherein applying the first voltage bias changes a refractive index of the waveguide by causing free charge carriers to be trapped within the dielectric layer.

9. The optical device of claim 1, wherein the non-volatile memory device comprises a heterogeneous metal oxide semiconductor capacitor (MOSCAP) integrated with both of the waveguide and the light emitting device.

10. An optical system comprising:
a bus waveguide;
a plurality of unit cells coupled to bus waveguide, wherein each of the plurality of unit cells comprises a respective resonator structure having a respective waveguide integrated with a respective light emitting device and a respective non-volatile memory device; and
one or more power sources electrically connected to the plurality of unit cells, the one or more power sources configured to, for each unit cell:
apply a respective seed voltage that causes the respective light emitting device to emit light at a respective first wavelength; and
apply a respective first voltage bias across the respective non-volatile memory device to permanently shift a wavelength of the light to a respective shifted wavelength,
wherein each unit cells couples light into the bus waveguide at a respectively different shifted wavelength.

11. The optical system of claim 10, wherein, after applying the respective first voltage bias, the one or more power sources are configured to apply a respective second voltage bias across the respective non-volatile memory device to tune the wavelength of the light to the respective first wavelength.

12. The optical system of claim 10, wherein at least one of the respective non-volatile memory device is a charge-trap memory device.

13. The optical system of claim 10, wherein at least one of the respective non-volatile memory devices comprises a heterogeneous metal oxide semiconductor capacitor (MOSCAP).

14. The optical system of claim 10, wherein at least one of the respective light emitting devices is disposed on a substrate, the at least one of the respective light emitting device including a first semiconductor layer disposed on a first side of a dielectric layer and on a first portion of a second semiconductor layer, wherein the second semiconductor layer is disposed on a second side of the dielectric layer, wherein the at least one of the respective light emitting device emits light into at least one of the respective waveguides, wherein the at least one of the respective waveguides comprises the first portion of the second semiconductor layer.

15. The optical system of claim 14, wherein at least one of the respective waveguides comprises the first portion of the second semiconductor layer, wherein the dielectric layer and the second semiconductor layer are provided in the at least one of the respective waveguides.

16. The optical system of claim 10, wherein at least one of the respective resonator structures is a micro-ring resonator and wherein at least one of the respective light emitting devices is a micro-ring resonator laser.

17. The optical system of claim 10, wherein at least one of the respective non-volatile memory devices includes a first portion of a second semiconductor layer, a dielectric layer, and a first semiconductor layer.

18. A method comprising:
applying a seed voltage bias to a light emitting device of an optical device to cause the light emitting device to emit light at a first wavelength, wherein the light emitting device emits light into a waveguide of the optical device;
applying a first voltage bias to a charge trap memory (CTM) device integrated with the light emitting device to cause a non-volatile wavelength shift of the light, emitted by the light emitting device, to a second wavelength; and
applying a second voltage bias to the CTM device to cause to shift the wavelength of the light, emitted by the light emitting device, to the first wavelength, wherein a polarity of the first voltage bias is opposite to a polarity of the second voltage bias,
wherein the CTM device and the light emitting device are formed in the waveguide.

19. The method of claim 18, wherein applying the first voltage bias causes an accumulation of trapped charges in the waveguide.

20. The method of claim 19, wherein applying the second voltage bias releases one or more of the trapped charges.
